(19) United States
(12) Patent Application Publication
(10) Pub. No.: US 2007/0103667 A1
(43) Pub. Date: May 10, 2007

(54) SUBSTRATE SUPPORT APPARATUS FOR USE IN A POSITION MEASURING DEVICE

(75) Inventors: Michael Ferber, Wetzlar (DE); Klaus Rinn, Heuchelheim (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Wetzlar (DE)

(21) Appl. No.: 11/554,338

(22) Filed: Oct. 30, 2006

(30) Foreign Application Priority Data
Nov. 4, 2005 (DE) DE102005052758.2

(51) Int. Cl. G03B 27/58

(52) U.S. Cl. 355/72; 355/53

(57) ABSTRACT

The invention relates to a substrate support apparatus (41) for use in a position measuring device (1) for determining the position of a substrate (30, 45) supported by the substrate support apparatus (41) by means of a laser interferometer system (29), wherein the substrate support apparatus (41) comprises a traversable stage construction (26, 42), and a stage mirror (9, 43) fixedly associated with the stage construction for reflecting a laser beam of the laser interferometer system, wherein it is suggested that the measurement-critical components, associated in a spatially fixed way, of the substrate support apparatus (41) in the combination of elements ranging from the stage mirror (9, 43) to the substrate (30, 45) are of material structures having moduli of elasticity which differ from that of the substrate (30, 45) by not more than 15%. As a result, the negative effects of air pressure fluctuations on the laser-interferometric position measurement can be greatly reduced.

### RELATED APPLICATIONS

This patent application claims priority of German Patent Application No. 10 2005 052 758.2, filed on Nov. 4, 2005, which is incorporated herein by reference.

### FIELD OF THE INVENTION

The present invention relates to a substrate support apparatus for use in a position measuring device for determining the position of a substrate supported by the substrate support apparatus by means of a laser interferometer system, wherein the substrate support apparatus comprises a traversable stage construction, and a stage mirror fixedly associated with the stage construction for reflecting a laser beam of the laser interferometer system.

### BACKGROUND OF THE INVENTION

A measuring device for measuring structures on wafers and masks used for their manufacture has been described in detail in the convention paper entitled “Pattern Placement Metrology for Mask Making” by Dr. Carola Blasing published for the Semicon, Education Program Convention in Geneva on Mar. 31, 1998. The description given there is the basis of the Leica LMS IPRO coordinate measuring device of the present applicant. For details about the functioning and structure of this measuring device explicit reference is made to the above publication and to the devices presently available on the market (currently Leica LMS IPRO 3). Since the present invention can be advantageously used with such a measuring device and will be primarily described with reference to such a measuring device, without prejudice to its general applicability, this measuring device will be described in the following with reference to annexed FIG. 1. The well-known measuring device 1 is for measuring structures 31 and their coordinates on a substrate 30, such as masks and wafers. In the production of semiconductor chips arranged on wafers with ever increasing integration the structural widths of the individual structures 31 become ever smaller. As a consequence the requirements as to the specification of coordinate measuring devices used as measuring and inspection systems for measuring the edges and the positions of structures 31 and for measuring structural widths become ever more stringent. Optical sampling techniques are still being favored in these measuring devices even though the required measuring accuracy (currently in the range of a few nanometers) is far below the resolution achievable with the light wave lengths used (spectral range in the near UV). The advantage of optical measuring devices is that they are substantially less complicated in structure and easier to operate when compared to systems with different sampling, such as X-ray or electron beam sampling.

The actual measuring system in this measuring device 1 is arranged on a vibration-damped granite block 23. The masks or wafers are placed on a measuring stage 26 by an automatic handling system. This measuring stage 26 is supported on the surface of granite block 23 by air bearings 27, 28. Measuring stage 26 is motor driven and displaceable in two dimensions (X/Y). The corresponding driving elements are not shown. Planar mirrors 9 are mounted on two mutually vertical sides of measuring stage 26. The laser interferometer system 29 shown is used to track the position of measuring stage 26 in the X direction.

The illumination and imaging of the structures to be measured is carried out by a high-resolution microscope optics with incident light and/or transmitted light in the spectral range of the near UV. A CCD camera serves as a detector 34. Measuring signals are obtained from the pixels of the CCD detector array positioned within a measuring window. An intensity profile of the measured structure is derived therefrom by means of image processing, for example for determining the edge position of the structure or the intersection point of two structures intersecting each other. Usually the positions of such structural elements are determined relative to a reference point on the substrate (mask or wafer) or relative to optical axis 20. Together with the interferometrically measured position of measuring stage 26 this results in the coordinates of structure 31. The structures on the wafers or masks used for exposure only allow extremely small tolerances. To inspect these structures, therefore extremely high measuring accuracies (currently in the order of nanometers) are required. A method and a measuring device for determining the position of such structures is known from German Patent Application Publication DE 100 47 211 A1. For details of the above position determination explicit reference is made to that document.

In the example of a measuring device 1 illustrated in FIG. 1, measuring stage 26 is formed as a frame so that sample 30 can also be illuminated with transmitted light from below. Above sample 30 is the illumination and imaging device 2, which is arranged about an optical axis 20. (Auto)focusing is possible along optical axis 20 in the Z direction. Illumination and imaging means 2 comprises a beam splitting module 32, the above detector 34, an alignment means 33, and a plurality of illumination devices 35 (such as for the autofocus, an overview illumination, and the actual substrate illumination). The lens displaceable in the Z direction is indicated at 21.

A transmitted-light illumination means with a height adjustable condenser 17 and a light source 7 is also inserted in granite block 23, having its light received via an enlarged coupling-in optics 3 with a numerical intake aperture which is as large as possible. In this way as much light as possible is received from light source 7. The light thus received is coupled-in in the coupling-in optics 3 into a light guide 4 such as a fiber-optic bundle. A coupling-out optics 5 which is preferably formed as an achromatic lens collimates the light emitted by light guide 4.

In order to achieve the required nanometer accuracy it is essential to minimize as far as possible interfering influences of the environment such as changes in the ambient air or vibrations. For this purpose the measuring device can be accommodated in a climate chamber which controls the temperature and humidity in the chamber with great accuracy (<0.01° C. or <1% relative humidity). To eliminate vibrations, as mentioned above, measuring device 1 is supported on a granite block with vibration dampers 24, 25.

The accuracy of determining the position of the structures is highly dependent on the stability and accuracy of the laser interferometer systems used for determining the X/Y stage position. Since the laser beams of the interferometer propagate in the ambient air of the measuring device, the wavelength depends on the refractive index of this ambient air. This refractive index changes with changes in the temperature, humidity and air pressure. Despite the control of temperature and humidity in the climate chamber, the remaining variations of the wavelength are too strong for the required measuring accuracy. A reference measuring distance referred to as an etalon is therefore used to compensate for measuring changes due to changes in the refractive index of the ambient air. In such an etalon a measuring beam covers a fixed metric distance (reference measuring distance) so that changes in the corresponding measured optical length can only be caused by changes in the measuring index of the ambient air. This is how the influence of a change in the refractive index can be largely compensated by the etalon measurement by continuously determining the current value of the wavelength and taking it into account for the interferometric measurement.

To further increase the accuracy, the lines of the laser wavelength can be split up, and additional interpolation algorithms can be used in the calculation of a position displacement.

To describe the accuracy of the measuring device described, usually the threefold standard deviation (3σ) of the measured average value of a coordinate is used. In a normal distribution of measuring values, statistically 99% of the measuring values are within a 3σ range about the average value. Indications as to repeatability are made by measuring a grid of points in the X and Y directions, wherein for each direction, after repeated measuring of all points, an average and a maximum 3σ value can be indicated. In the LMS IPRO measuring device of the applicant, for example, the repeatability (maximum value 3σ) of 4-5 nm could be improved to below 3 nm.

A further improvement of the repeatability and therefore of the measuring accuracy of the measuring device described is desirable. Special attention has been paid in the present invention to the laser interferometer used for coordinate measurement of the measuring stage or for determining changes in the coordinates of this measuring stage. It is noted that the present invention is not limited to interferometers in the context of the measuring device described but can generally be used in laser-interferometric measurements.

### SUMMARY OF THE INVENTION

There is therefore a need to improve the repeatability or more generally the measuring accuracy in the laser-interferometric determination of the position of a substrate held by a substrate support apparatus, and to uncouple it from external atmospheric influences.

To achieve this a substrate support apparatus is provided for holding substrates in a position measuring device for determining the position of a substrate supported by the substrate support apparatus, comprising by a laser interferometer system, a traversable stage construction, a stage mirror fixedly associated with the traversable stage construction for reflecting a laser beam of the laser interferometer system, wherein measurement-critical components, like a mirror body on a side of substrate the support apparatus, the substrate support, the substrate and/or the etalon are spatially related and are of material structures having moduli of elasticity which differ from that of the substrate by not more than 15%.

The substrate support apparatus according to the present invention is distinguished in that the components, associated in a spatially fixed way, critical to the measurement of this substrate support apparatus are measured in the combination of elements ranging from the stage mirror to the substrate of materials or, more generally, material structures having moduli of elasticity which differ from that of the substrate by no more than 15%.

The above upper limit of 15% can be preferably reduced to 10%, more preferably to 5%. In particular it is advantageous if the moduli of elasticity of the above components essentially match the modulus of elasticity of the substrate. The allowed deviation of the moduli of elasticity of the components from that of the substrate mainly depends on the required measuring accuracy. As explained in the following, it has in fact been shown that air pressure fluctuations during a position measurement have an influence on the measuring accuracy and that these air pressure fluctuations can be largely compensated for by having the substrate support apparatus constructed, in the critical area, of materials having moduli of elasticity which are virtually the same.

Herein attention must be paid to the fact that the laser interferometer system(s) in the above substrate support apparatus tracks or track a displacement of the stage mirror(s) reflecting the laser beam of a laser interferometer system. For determining the position of the substrate or for coordinate measurement of a position on said substrate it is assumed that the substrate is displaced in the same manner as the stage mirror(s). The present invention is therefore based on the idea that within the combination of elements ranging from the stage mirror to the substrate, displacements can occur so that a measured position displacement of the stage mirror can no longer be transferred to the corresponding position displacement of the substrate 1:1. It has been shown that such position displacements within the above combination of elements may largely be due to atmospheric air pressure changes.

FIG. 2 schematically shows the interdependence of air pressure changes and repeatability (3σ) in the X and Y directions in the initially described LMS IPRO coordinate measurement device of the applicant. Three measuring curves are shown which were taken within two days at intervals of four hours each. The position of points was measured in the X and Y directions equidistantly in the form of a 15×15 grid. For each measuring point of the curves the grid was measured ten times. Measuring curve 100 indicates the Y repeatability, i.e. maximum 3σ value in the Y direction, measuring curve 200 indicates the X repeatability, i.e. maximum 3σ value of the measurement in the X direction. Measuring curve 300 indicates the standard deviation of the simultaneously measured etalon value as a measure for the change in air pressure.

A comparison of measuring curves 100 and 200 with measuring curve 300 shows an interdependence between repeatability (3σ) and air pressure fluctuations. Changes in the air pressure cause an enlargement or reduction of the measured grid which leads to a deterioration of the repeatability. If this enlargement/reduction is calculated out of the measuring values (by software-based compensation of the measured grids) there is a marked improvement of the repeatability in runs with strong air pressure fluctuations. The repeatability was improved from 1.72 nm and 2.44 nm in the X and Y directions, to 1.31 nm and 1.75 nm, respectively, i.e. by about 25%. The measuring data showed a change in the enlargement/reduction of the grid of about 0.01 ppm with an overall air pressure change of 2 mbar. This results in a change in the position of 1.4 nm (at a dimension of the measuring area of 140 mm).

In FIGS. 3A and 3B the “etalon” (proportional to the difference of the interferometric distance measurement of the etalon to a 0 point (chosen at random)) or the “scale” (proportional to a calculated enlargement change which would optimally match the individual measuring grid) was plotted against the “loop” (a run through the 15×15 measurement grid). When comparing the etalon changes proportional to the air pressure at constant temperature and humidity according to FIG. 3A with the enlargement changes of the measured grid, as shown in FIG. 3B, the result is that no unequivocal, clear interdependence can be found between a grid change and the air pressure. Rather a continuous fluctuation of the grid enlargement can be observed in both the X and Y directions wherein, however, the fluctuation width and the frequency is noticeably increased during the peak in the air pressure (about loop 75 through 110). This is why further reasons must be found which would explain the influence of an air pressure change on the repeatability. To do this the structure of the substrate support apparatus of the measuring device was more closely investigated.

The substrate support apparatus has a stage construction which is usually traversable so that certain positions to be measured on the substrate can be reached. A stage mirror is also necessary to reflect a laser beam of the laser interferometer system. The stage mirror can be mounted, for example, directly on the stage construction, wherein usually two stage mirrors are present on mutually vertical stage edges so that displacements of the stage can be measured in the X and Y directions. It is also possible, however, to realize the stage mirror as an independent mirror body connected to the stage construction. Such a mirror body is of a Zerodur frame, for example, the sides of which are polished and mirrored. The mirror body rests on the stage construction or is mechanically connected to the latter.

A laser interferometer system, in the above substrate support apparatus, subsequently always measures position displacements of the stage mirror and therefore displacements of the stage construction or the mirror body. The position displacements measured are assumed to be equal to displacements of a position on the substrate (for example grid, mask or wafer). As a consequence, in the above structure of a substrate support apparatus, deformations of the substrate (such as the above grid) and changes in the distance from the stage mirror to the substrate have been directly introduced into the error budget of the measuring device without correction mechanism. It has now been found that the initially described experimental findings can be explained by the elasticity of the materials used. In order to estimate a change in the length of the materials used due to a change in the air pressure, the modulus of elasticity of the materials used has to be known. The following table indicates the moduli of elasticity of the materials relevant for measurements in a typically used substrate support apparatus of an LMS IPRO of the present applicant;

TABLE 1

| | | Modulus of elasticity |
|---|---|---|
| Material | Used for | (·10¹⁰ Pa) |
| Silica glass | Mask | 7.3 |
| Zerodur | Mirror body | 9 |
| Kyocera ceramic | Mask frame | 13.3 |
| Invar, rolled | Stage | 14 |
| | construction | |

In the above indicated measuring values, pressure changes of about 2 mbar (=200 Pa) occurred. This explains an enlargement/reduction of for example about 0.003 ppm (or about 0.5 nm in a 6 inch mask as the substrate). These values are no longer negligible at 3 times the standard deviation of about 2 nm. In the present invention, therefore, the substrate support apparatus, in the critical area of the combination of elements ranging from the distance measuring means (stage mirror) to the measuring substrate, was constructed principally of materials having closely matching moduli of elasticity, which in turn should closely match that of the substrate. In this case the deformations due to changes in the air pressure are simple changes in scale. According to the present invention it has therefore been achieved that air pressure deformations result in simple drifts in scale; this is how the influence of air pressure can be compensated by changing the distance unit as a function of the air pressure (i.e. of the value for the laser wavelength in the case of interferometric measurements). This compensation can be done, for example, on the software side.

The “measurement-critical” components, associated in a spatially fixed way, of the substrate support apparatus according to the present invention are those components of which the changes in length are relevant for the measurement. For example, if the stage mirror is mounted on a stage construction which in turn carries a substrate in a substrate support (e.g. carrier or frame) the measurement-critical components are: stage mirror, stage construction, substrate support. However, if an independent mirror body is present which in turn carries the substrate with a substrate support, the measurement-critical components are: mirror body and substrate support. In this case, if the substrate rests directly on the mirror body or is carried by the latter, the only remaining measurement-critical component is the mirror body itself. With reference to this extensive explanation a person skilled in the art will easily identify the measurement-critical components of a substrate support apparatus of a different structure.

In the substrate support apparatus according to the present invention it is further advantageous if the mirror body, on its bottom and/or top surface has support points for the stage construction and/or for the substrate or a substrate support. Such a substrate support apparatus is known from DE 198 58 428 C2. The advantage of such an arrangement is that the stage construction, the mirror body and the support for the substrate/object or the substrate itself only touch at the support points, and the weight of the substrate, with support points arranged on top of each other, is vertically supported directly on the stage construction. This effect can be enhanced in that connection elements (connecting bars or bolts) vertically extend through the mirror body, the two ends of each of the connecting elements forming said support points on the top and bottom surfaces of the mirror body. In this case the substrate or the substrate support directly comes to rest on the top end of the connecting element and is directly supported on the stage construction, without touching or stressing the mirror body. In practice connecting elements of steel (steel bolts) have proven useful which are glued into the mirror body. Further details of this construction and their advantages can be seen from the above patent specification.

It has been found that in the above described construction of a substrate support apparatus with components of different moduli of elasticity a further effect occurs which negatively affects measuring accuracy. This effect may be illustrated with reference to FIG. 4. The figure schematically shows a substrate support apparatus 41 with a stage construction 42, a mirror body 43 arranged thereon, and a substrate 45 (e.g. a mask) arranged above it, and a substrate support 44 (e.g. a mask frame), wherein advantageously three connecting elements 46 (here connecting rods) are provided, extending through mirror body 43 in a vertical direction. A change in the air pressure basically has an effect on the substrate support apparatus in spherical symmetry. In most of the measuring devices changes in the vertical (z) are not critical since suitable compensation means (such as auto-focusing) are provided. Other deformations have an effect in the direction of the laser axes of the interferometer system and cause a change in the distance between mirror body 43 and substrate 45 (indicated with a double arrow). These effects have been discussed in detail above. Other effects which occur are “lever effects” which have been shown as arrows having double lines. As the air pressure is increased, mirror body 43 (Zerodur) will be deformed more noticeably than stage construction 42 (Invar), i.e. the two components will be offset from each other. This offset has an effect on the connecting elements 46 which will amplify this effect as levers. The forces caused hereby can compress substrate 45 and substrate support 44. Similarly, mask 45 will be more strongly deformed than mask frame 44. With larger forces and deformations, the static friction of each of the support points may be overcome, which may lead to a displacement of the substrate with respect to the substrate support, of the substrate support with respect to the mirror body and/or of the mirror body with respect to the stage construction.

These effects can be avoided by having the moduli of elasticity of the above components of the substrate support apparatus according to FIG. 4 tuned to each other, i.e. match each other as far as possible. Another possibility to reduce the above effects is by correspondingly setting the planes formed by stage construction 42, mirror body 43 and substrate support 44. The support points created by the three connecting elements 46 must be configured in such a way that the individual components do not stress each other.

In order to achieve a minimum difference in the moduli of elasticity of the measurement-critical components of a substrate support apparatus according to the present invention it is advantageous if at least one of the components is of a laminate or of a conglomerate of materials. In such material structures differing deformations of materials involved in the laminate or conglomerate can largely offset each other with a suitable selection of materials. The advantage of this is a greater freedom in the selection of materials. The materials in question must have moduli of elasticity which straddle the desired value. The ratio of the amount of materials is derived from the difference in the moduli of elasticity with respect to the desired setpoint value.

As initially mentioned, the present substrate support apparatus is particularly well suited for a position measuring apparatus to determine the position of a substrate by means of a laser interferometer system. The position measuring apparatus can be a coordinate measuring device for measuring structures on a substrate, such as a mask or a wafer, or for determining coordinates of such structures. An example of such a position measuring device is the LMS IPRO coordinate measuring device of the applicant, which was extensively discussed above.

In such a position measuring device there is a further possibility to increase the measuring accuracy using an etalon, by which, as initially described, a reference distance is provided for the laser interferometer system. If the etalon (normal length) is of a material having a modulus of elasticity which differs from that of the substrate by less than 15%, i.e. when the modulus of elasticity of the etalon essentially matches that of the measurement-critical components of the substrate support apparatus, the normal length changes with the substrate to be measured or the measurement-critical component. In this case the dependence on the air pressure of the measurement is automatically precisely compensated, so that subsequent (software-side) compensation of the scale drift can be omitted. This embodiment is therefore particularly preferred with a position measuring device according to the present invention.

### BRIEF DESCRIPTION OF THE DRAWINGS

An exemplary embodiment of the present invention and its advantages will be more closely described in the following with reference to the accompanying drawings, in which:

FIG. 1 schematically shows the structure of a coordinate measuring device with a substrate support apparatus,

FIG. 2 shows the measuring result versus time of the X, Y repeatability in a coordinate measurement device, and the associated standard deviations of the etalon values as a measure for air pressure changes with a substrate support apparatus according to the state of the art,

FIG. 3 shows the associated etalon changes for the measurements according to FIG. 2 as a measure for the air pressure (FIG. 3A) and the respective changes in size in the X and Y directions (FIG. 3B),

FIG. 4 shows a substrate support apparatus according to the state of the art to illustrate the effects of air pressure fluctuations, and

FIG. 5 shows an embodiment of a substrate support apparatus according to the present invention.

### DETAILED DESCRIPTION OF THE PREFERRED EMBODIMENTS

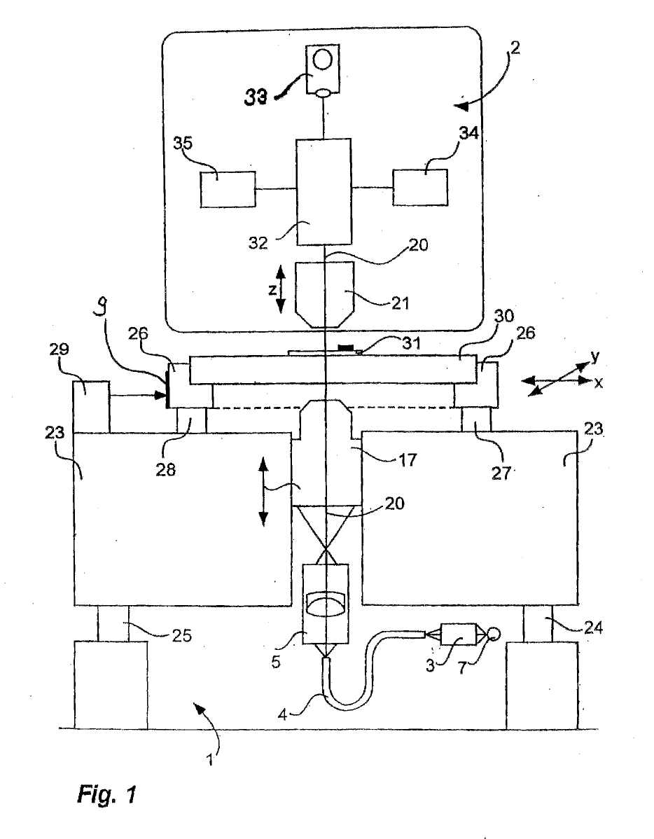

A coordinate measurement device according to FIG. 1 has already been extensively described in the introduction to the description. It is noted again that the substrate support apparatus according to the present invention can be used advantageously in such a coordinate measurement device or more generally in a position measuring device.

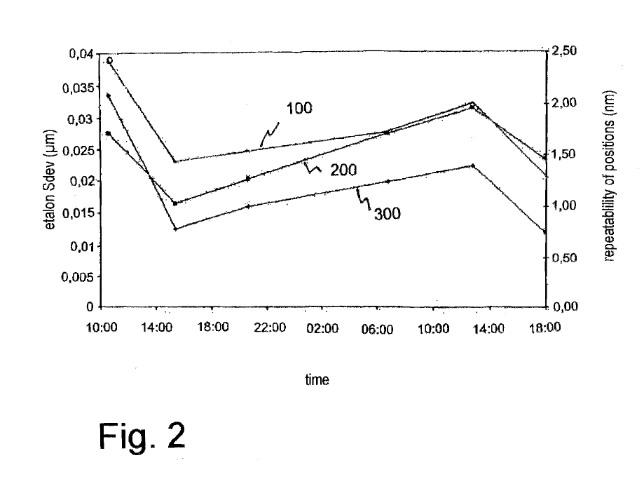

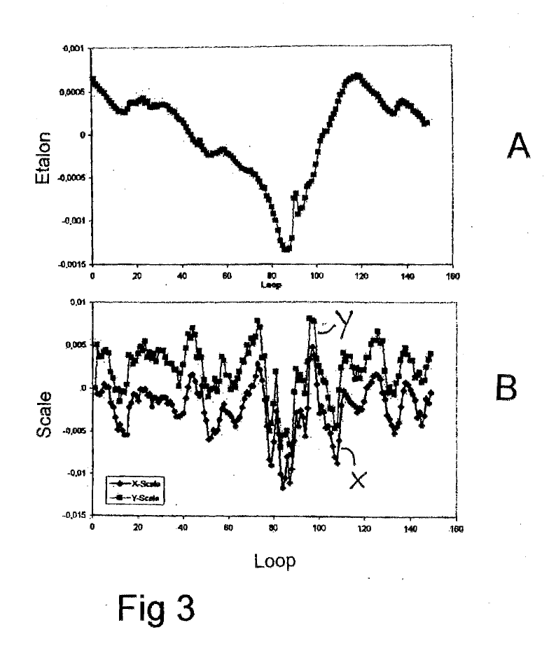

FIGS. 2 to 4 have already been discussed to explain the invention.

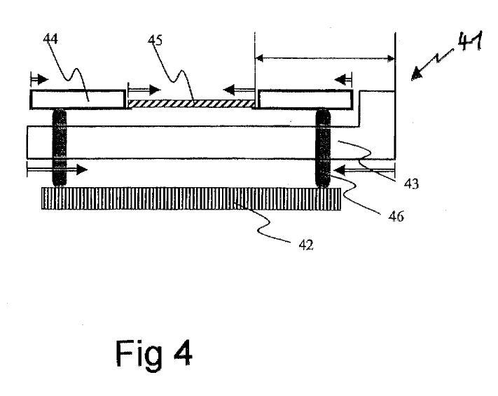

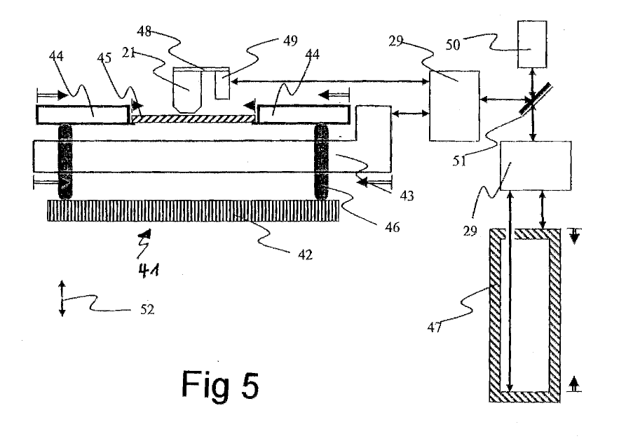

FIG. 5 shows an embodiment of a substrate support apparatus according to the present invention in which the measurement-critical components are made of material structures having moduli of elasticity differing from that of the substrate 45 to be investigated, here a mask, by not more than 10%. Equal components have been indicated with the same reference numerals as in FIG. 4. FIG. 5 further schematically shows the arrangement of laser interferometer system 29 and etalon 47. A laser gun 50 emits a laser beam 52 which is directed into a laser interferometer system 29 by a beam splitter 51. The laser beams are shown as double arrows in FIG. 5, wherein not every one of the double arrows has been indicated with reference numeral 52 for clarity. Laser interferometer system 29, in turn, transmits a reference laser beam to reference mirror 49 which is usually on a lens holder 48 of lens 21. Laser interferometer system 29 further sends a measuring beam to the corresponding position of mirror body 43. With this arrangement a displacement of mirror body 43 relative to reference mirror 49 can therefore be measured by laser interferometry. A further laser interferometer system 29 simultaneously measures the reference measuring distance formed by etalon 47.

With an increase in the air pressure there is a deformation of the components. Deformations in the Z direction can usually be compensated by an autofocusing means of the position measuring device. Deformations in the X and Y direction, on the other hand, are directly reflected in the error budget of the position measurement device. The measurement-critical components of substrate support apparatus 41 shown in FIG. 5 are: mirror body 43 on the side of substrate support apparatus 41, and substrate support 44 (mask frame) and substrate 45 (mask) itself on the other side. Since according to the present invention these components are of materials or material structures having essentially the same moduli of elasticity, a deformation in the X and Y directions, with air pressure fluctuations, results in a reduction or enlargement of the components involved proportional to the object dimensions (cf. arrows with double line). Such an enlargement/reduction therefore corresponds to a drift in scale which can be compensated (for example by a correction calculation). In the laser interferometric measurement of the position of mirror body 43, this compensation is carried out by correspondingly changing the value of the laser wavelength. In particular this type of compensation can be precisely carried out automatically by using etalon 47 as the normal length, the modulus of elasticity of which essentially matches that of the above critical components of substrate support apparatus 41. In this case the basic normal length changes with the air pressure, so that the air pressure dependency of the measurement is automatically precisely compensated.

What is claimed is:

1. A substrate support apparatus for holding substrates in a position measuring device for determining the position of a substrate supported by the substrate support apparatus, comprising by a laser interferometer system, a traversable stage construction, a stage mirror fixedly associated with the traversable stage construction for reflecting a laser beam of the laser interferometer system, wherein measurement-critical components, like a mirror body on a side of substrate the support apparatus, the substrate support, the substrate and/or the etalon are spatially related and are of material structures having moduli of elasticity which differ from that of the substrate by not more than 15%.

2. The substrate support apparatus according to claim 1, wherein the stage mirror is mounted on the stage construction.

3. The substrate support apparatus according to claim 1, wherein the stage mirror is configured as an independent mirror body connected to the stage construction.

4. The substrate support apparatus according to claim 3, wherein the mirror body, on its top surface, has support points for the substrate or the substrate support.

5. The substrate support apparatus according to claim 3, wherein the mirror body, on its bottom surface, has support points for the stage construction.

6. The substrate support apparatus according to claim 4, wherein a plurality of connecting elements extend through the mirror body in a vertical direction, and the ends of the connecting elements are said support points.

7. The substrate support apparatus according to claim 3, wherein the stage construction is of a material structure having a modulus of elasticity which differs from that of the mirror body by not more than 15%.

8. The substrate support apparatus according to claim 1, wherein at least one of the measurement-critical components of the substrate support apparatus is of a laminate of material.

9. The substrate support apparatus according to claim 1, wherein one of the measurement-critical components of the substrate support apparatus is of a conglomerate of material.

10. The substrate support apparatus according to claim 1, wherein the moduli of elasticity differ from each other by not more than 10%, in particularly by not more than 5%, and are in particular the same.
